(19) United States
(12) Patent Application Publication
(10) Pub. No.: US 2006/0095345 A1
(43) Pub. Date: May 4, 2006

(54) System and method for an online catalog system having integrated search and browse capability

(75) Inventors: Chong I. Ka, Redmond, WA (US); Delane R. Hewett, Bellevue, WA (US); Mackenzie Steele, Bellevue, WA (US); Srivaths B. Copparam, Issaquah, WA (US)

Correspondence Address: SHOOK, HARDY & BACON L.L.P.;(c/o MICROSOFT CORPORTATION), 2555 GRAND BOULEVARD, KANSAS CITY, MO, 64108-2613, US

(73) Assignee: Microsoft Corporation, Redmond, WA (US)

(21) Appl. No.: 10/974,804

(22) Filed: Oct. 28, 2004

(51) Int. Cl. G06F 17/30

(52) U.S. Cl. 705/27

(57) ABSTRACT

A system and related techniques generate and maintain a unified product index, to perform searching and browsing in an online product, service, content or information catalog. A user investigating, for example, a set of retail offerings of digital cameras may for instance browse through a Web site layout or taxonomy to locate products of interest, such as cameras having resolution in the range of 3-4 megapixels or in the price range of $200-300. Alternatively, the user may input search terms in a search dialogue box to locate those or other features. Unlike conventional e-commerce platforms in which search may be performed against structured databases while browsing may access unstructured HTML or other descriptive material, according to the invention navigation and searching may be integrated and both access a structured index derived from product descriptions as well as traditional SQL or other structured data. A user may thus transparently move between browsing the Web site and searching the Web site, refining their search or browsing activity in a seamless fashion. The HTML or other unstructured data may in one regard be processed by an index engine to identify product attributes such as type (electronics), size, price, weight or other specifications as well as attribute values, which may be sorted or stored in a separate table. A set of results generated by conducting an initial search may thus be continued or refine by further browsing down to a particular product or other level of detail. Conversely a user who has browsed to a given level of detail, such as digital camcorders priced less than $700, may initiate a search through products at that level of the hierarchy without resetting search terms or position in the taxonomy. Greater ease of use, more efficient location of products or services and less dead-end pathways are thus achieved.

### CROSS-REFERENCE TO RELATED APPLICATION

Not applicable.

### STATEMENT REGARDING FEDERALLY SPONSORED RESEARCH OR DEVELOPMENT

Not applicable.

### FIELD OF THE INVENTION

The invention relates to the field of electronic commerce, and more particularly to a system and method for presenting a product or service catalog to a user over a network connection, and permitting the user to either search or navigate to items of interest using an integrated interface accessing a unified catalog index and related tools.

### BACKGROUND OF THE INVENTION

The proliferation of online retail and other vendor sites has led to a desire to enhance the user's shopping or other commercial experience. The number and type of goods and services marketed on the Internet has burgeoned to a point that some vendors may present users with not just a few product types and selections, but dozens, hundreds, thousands or more of given product or service categories. For example, vendors who market automobile parts may offer hundreds or thousands of common parts or services, such as air filters, spark plugs or a host of other parts or products, each of which may be differentiated for various manufacturers, years and models of vehicles. Computer hardware or software vendors, clothing merchandisers, book or other publishing retailers and others may similarly stock or offer a large quantity and variety of goods, products or services. Presenting those wide ranges of product choices can become a cumbersome consumer experience on an Internet Web site that does not permit a user to select various product or service categories, or to enter search terms to locate items of interest.

While some Internet retailers, manufacturer and others sites may present a user with a search dialog, and may also present the user with a product tree, hierarchy or “taxonomy” which permits a user to keep drilling into further product details, categories or other breakdowns, those search and browse facilities are typically not unified. That is, a user may be able to navigate up and down a list of parts for a given make and model of car, the user may not be able to refine the product categories or parts results with an impromptu search at a given level. Conversely, a user who has performed a search to find parts for a 2000 Mercedes Benz sedan may not be able to extend those results by navigating to related parts, in browsing fashion.

The disjointed quality of product search and browse may be due in part to the fact that on many conventional electronic commerce platforms, the source data used to supply product information for searching and the source data used to supply information for browsing may not be or formatted as the same data. That is, product or service data which may be used to permit users to perform free searches may typically be encoded in a structured database format, such as structured query language (SQL) or other relational or other scheme. On the other hand, the descriptive information used to portray products or services on a browsable Web site may be stored or encoded in non-database format, such as in hyper text markup language (HTML), extensible markup language (XML) or other code or format. Conducting a search on that type of descriptive informational, advertising or other material may therefore be difficult or impossible.

The user may therefore have to stop a navigation or browsing session or accumulated results, in order to back out and access a search dialog or other search tool when more particular results are desired. Users who do so may however not be searching or accessing the same or consistent descriptive content, so that, for instance, parts or products found by navigation may not be located when a search is performed, or vice versa. Other problems in electronic commerce platforms exist.

### SUMMARY OF THE INVENTION

The invention overcoming these and other problems in the art relates in one regard to a system and method for an online catalog system having an integrated search and browse capability, in which product descriptors and other information is processed and stored to a searchable catalog index. In embodiments, product specifications, descriptions, images, pricing and other data may be extracted from Web pages or other sources, and stored to the catalog index in structured or hierarchical form. With Web or other descriptors stored to structured form, a user may navigate an online catalog or other e-commerce site, and initiate search or browsing activity accessing that index. Upon locating a product or service of interest, the user may extend or refine their search or browsing activity with, for example, additional search terms. According to embodiments of the invention in one regard, the user may move freely and seamlessly in and out of search activity and browsing modes. The user may thus transparently iterate or refine their product results, without a need to start navigating or searching over again each time a change from keyword searching to site-category browsing, or vice versa, is made.

### BRIEF DESCRIPTION OF THE DRAWINGS

FIG. 1 illustrates an environment in which a system and method for integrated search and browse functionality may be implemented, according to embodiments of the invention.

FIG. 2 illustrates a schema which may be used in a catalog index, according to embodiments of the invention.

FIG. 3 illustrates a user interface for integrated search and browse functionality, according to embodiments of the invention.

FIG. 4 illustrates a flowchart of overall search and browsing processing, according to embodiments of the invention.

### DETAILED DESCRIPTION OF EMBODIMENTS

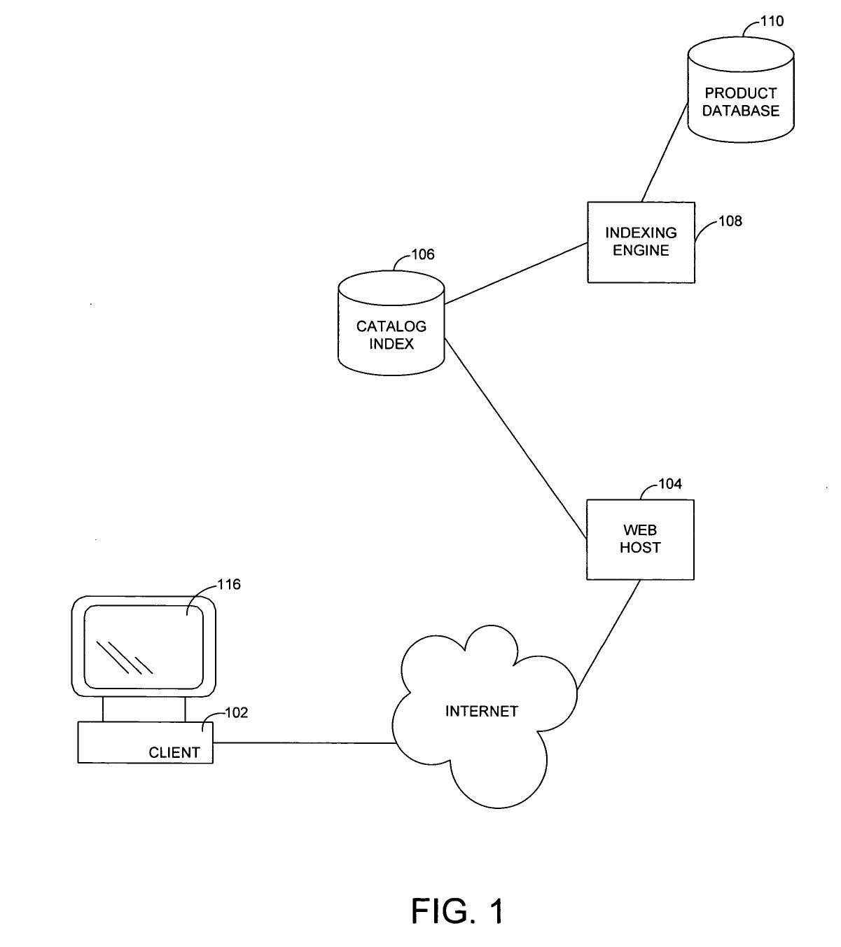

FIG. 1 illustrates an architecture in which a system and method for integrated search and browse capability in an online catalog system may operate, according to an embodiment of the invention. As illustrated in that figure, a user may operate a client 102, such as a computer or other device, via user interface 116 such as a graphical interface to perform file management, application, network access and other tasks or functions. In embodiments as shown, the user may access a Web host 104 via the Internet or other network or connection, for instance using a browser to perform online shopping, purchasing or other commercial activities or transactions. That online activity may include, for example accessing Web host 104 or other site or portal to view an online catalog, or other itemized, listed, enumerated or other commercial or transaction engine. For example, Web host 104 or other portal or site may host and present goods, products, services, audio or visual content including downloadable music or video files, or other information or content, for instance for purchase, rental, lease or other commercial or other purposes. Those goods, products, services, content or information may include, for example, book catalogs or collections, automobile parts or services, household or hardware items, clothing, pharmaceuticals, medical items, media subscriptions or other products, goods, services, information or content.

According to embodiments of the invention in one regard, the Web host 104 may communicate with a catalog index 106 storing an index of the products, goods, services, information or other content advertised or available for sale, order, rental, lease or other commercial transaction on that site. However, in contrast to conventional e-commerce Web platforms in which, for example, book titles or clothing selections may be stored and presented in an unstructured or unsearchable form in a hyper text markup language (HTML) or other format, according to embodiments of the invention the catalog index 106 may be constructed and generated in a structured or hierarchical fashion, to permit a user of client 102 or other device to either meaningfully navigate or browse the available content of Web host 104, in a unified fashion and without having to switch back and forth between separate browsing tools and searching tools.

More specifically, content stored in catalog index 106 may according to embodiments of the invention be generated or maintained by an indexing engine 108 which in turn communicates with a product database 110, which database may act as a source of descriptive, attribute, image or other information which may be abstracted to populate catalog index 106. That is, product database 110 may contain or store descriptions of product, goods, services, media content or other information in unstructured HTML, extensible markup language (XML) or other structured or unstructured format. That content may include, for example, advertisements, images or specifications for commercial goods or services such as books, subscriptions, clothing, medical or health services, computer hardware or software or other products, goods, services, content or information. That data may be supplied, for example, by the manufacturers, vendors or advertisers of those goods, services, content or information, to promote the marketing of that commercial material or information. That data may be supplied from diverse sources, and may in embodiments not necessarily be furnished or stored in a structured, relational or searchable format.

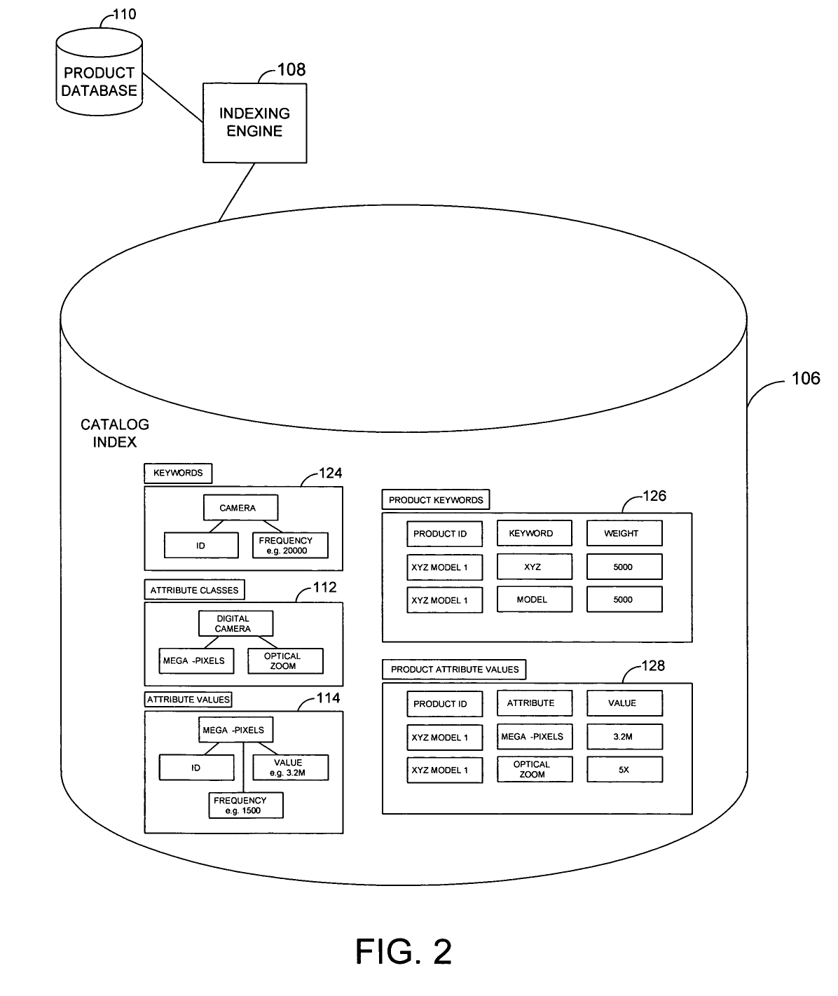

However, according to embodiments of the invention indexing engine 108 may access and analyze that source information and extract product, service, content or information details or attributes, and store them to indexing catalog index 106, in a structured or relational data store which then may be searched or navigated, in an integrated fashion. Thus, and as for example illustrated in FIG. 2, the indexing engine 108 may parse source advertisements, specifications, images or other data, and transmit product, service, content or information attributes and values to the catalog index 106 for storage in a set of relational database tables or other relational, hierarchical or structured format. For instance indexing engine 108 may traverse an XML descriptor to extract product attributes for automobile parts, to extract for instance a descriptor or category of “tires” which descends into further nodes such as “all-weather”, “radial”, “spares” or others, or which indicates values such as price, tire diameter, matching vehicle makes or other information. According to embodiments of the invention as shown, the indexing engine 108 may extract that and other information from product database 110 for storage to one or more tables, or other data objects or formats.

Those tables or other objects may include, as illustrated, a set of attribute classes 112, a set of attribute values 112, a set of keywords 124, a set of product keywords 126 and a set of product attribute values 128. In embodiments as shown, the set of attribute classes 112 may store a set of entries or objects indicating product, service, content or information attributes such as an illustrative product category of “digital camera”, which may be descend to further categories such as “mega-pixels”, “optical zoom” and others, each of which may entail further attributes, labels or other identifiers. For instance “optical zoom” may resolve into categories or attributes of “2-4×zoom”, “4-8×zoom”, “electronically enhanced zoom” or others.

According to embodiments of the invention in a corresponding regard, the catalog index 106 may similarly store specific values for attributes in a set of attribute values 112, so that, for example, a digital camera or other product identified by a given pixel resolution of 3.2 megapixels may resolve to further attributes such as memory type, battery life, frequency of search term inquiries or other measures, or other attributes or characteristics enumerated in the set of attribute values 114. Likewise, the catalog index may store a set of product keywords 126 which may record product descriptors such as “product ID”, “keyword”, “weight”, “price”, “model” or others, which may apply to one or more sets of catalogued products. The catalog index 106 may similarly store a set of product attribute values 128 which may record manufacturer model number, product ID, pixel resolution, zoom or other values for catalogued goods, products, services, content or information. Thus the schema used to categorize or organize the set of product, service, content or information attributes in set of attribute classes 112 may be separated from the specific values of those entries for specific manufacturers, products, services, content or information, but logically linked by key fields or other links or terms, such as product ID or others. However, a user manipulating user interface 116 to view the content of Web host 104 may consequently be able to either navigate or search all available categories or levels for desired products, services or content based on an interrogation of catalog index 106, in seamless fashion.

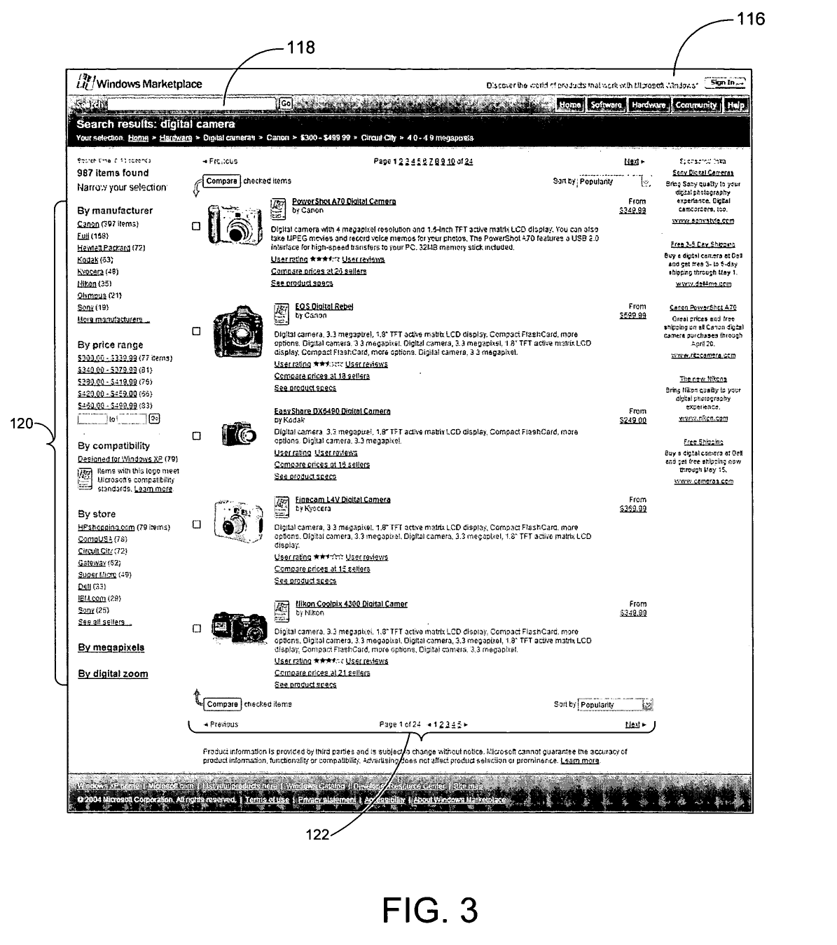

Thus, for example and as illustrated in FIG. 3, a user may operate user interface 116 to manipulate a search tool 118, such as a search term input box or dialogue, and browsing tool 120 such as a set of selectable links, through one integrated or unified interface or set of interfaces. In embodiments as shown, the user may thus illustratively select a digital camera product from a categorized list of links displaying camera products having different manufacturers, price ranges, software compatibility, pixel resolution ranges or other attributes or specifications using links in browsing tool 120. The user may likewise directly enter a desired model number, manufacturer or search term or terms into search tool 118. Using either pathway, the Web host 104 may in embodiments access the catalog index 106 to run searches or matches against set of keywords 124, set of attribute classes 112, set of attribute values 112, set of product keywords 126, set of product attribute values 128, the intersection or other operation on those or other sets or tables, or operate against other data stored in catalog index 106 to present the user with a set of results 122. The set of results 122 may in embodiments be or include a list or matrix of matching products, goods, services, content or information. Other formats for presenting the set of results 122 are possible. The listing or other result format in set of results 122 may itself be searchable via search tool 118, for instance to refine the hits or results according to additional criteria or key terms against catalog index 106. The listing or other result format in the set of results 122 may likewise be browsed or navigated, for instance by clickable otherwise selectable links, to descend into further product details or categories, also accessing catalog index 106.

In embodiments, the set of attribute classes 112, set of attribute values 112 or other content of catalog index 106 may be structured to enhance search speed or other performance characteristics, for example by placing frequently-searched key words in a cache, or other efficient data store. Semantic or query processing may likewise enhance attributes, key words or phrases or other data stored in catalog index 106, for instance to pre-join common attributes or terms into frequently used criteria, to reduce pathways to common terms, or supply other performance enhancements.

When a set of results 122 is generated and delivered, the user may perform further or additional refinements to attributes, keywords or perform other iterations, or begin a new search, enter further criteria, or browse further selections. In general, however, the user may freely and continuously navigate or search on the content of catalog index 106 via Web host 104, without having to stop to re-enter search terms, re-navigate to different points in the product, service, content or information taxonomy, or to repeatedly access different tools for various searching functions and browsing functions. The quality of user experience and efficiency of search operations may therefore be enhanced.

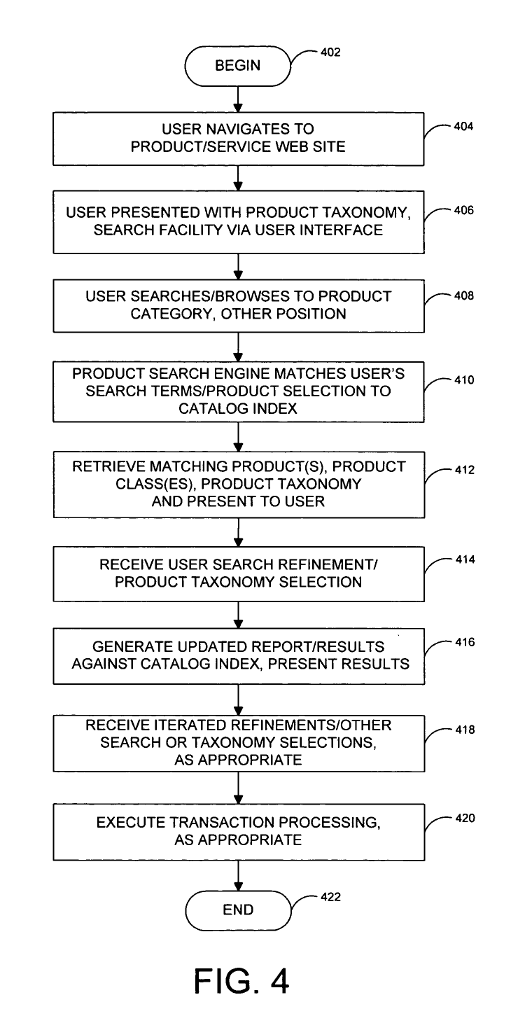

Overall integrated search and browse processing in an online catalog or other environment is illustrated in FIG. 4. In step 402, processing may begin. In step 404, a user may navigate to a product, goods, services or other retail, wholesale or other commercial or other Web site or destination, such as an online product ordering site supported by Web host 104. In step 406, the user may be presented with an integrated search and browse experience including search tool 118 and browsing tool 120, for instance via user interface 116 such as a graphical user interface on client 102, or otherwise.

In step 408, the user may browse or search to a position within the Web or other site taxonomy, for example to a product or service category such as “non-fiction paperback books” within an electronic bookstore, or “digital video cameras” in an online electronics catalog. In step 410, a Web host 104, such as a Web site server or other host, may match the user's search terms or navigated product or service position to the catalog index 106. In step 412, any one or more matching products or services, classes or categories of products or services, taxonomy positions or other results may be generated and presented to the user, for example by updating the user interface 116 to show matching books, video cameras, or other goods, products or services within refreshed windows or panes, along with position identifiers or highlights of attributes. In step 414, the Web host 104 may receive search refinements or further product or service selections from the user, for example to search or browse to books published in the year “2004”, or based on other or extended criteria.

In step 416, an updated report or results may be generated against the catalog index 106, and for example presented to the user via user interface 116. In step 418, the Web host 104 may received further or iterated refinements to search terms or other search or taxonomy selections, as appropriate from the user. In embodiments the user may repeatedly alter or refine those positions within the taxonomy or search terms inputted to the search tool 118. In step 420, any ensuing transaction processing, such as execution of an online purchase order, may be executed as appropriate. For instance a selected product or service may be identified, checked into a shopping card and paid for via an electronic charge to a credit card, or other transaction processing may take place. In step 422, processing may return to a prior processing point, jump to a further processing point, repeat or end.

The foregoing description of the invention is illustrative, and modifications in configuration and implementation will occur to persons skilled in the art. For instance, while the invention has generally been described in terms of a user accessing a public Web site, in embodiments the user may access other types of sites via other networks or connections, such as intranets or other public, private or other networks.

Similarly, while the invention has in embodiments been described as operating on a single catalog index 106, in embodiments the search index may be distributed across multiple databases, data stores or servers. The source product database 110 may similarly be implemented using multiple databases, data stores or servers. Other hardware, software or other resources described as singular may in embodiments be distributed, and similarly in embodiments resources described as distributed may be combined. The scope of the invention is accordingly intended to be limited only by the following claims.

We claim:

1. A system for generating a searchable catalog index, comprising:
a first interface to a source database storing a set of product, service, content or information descriptions;
a second interface to a searchable catalog index; and
an indexing engine, the indexing engine communicating with the first interface and the second interface to receive the set of product, service, content or information descriptions, generate a structured representation of the product, service, content or information descriptions and store the structured representation to the searchable catalog index.

2. A system according to claim 1, wherein the searchable catalog index comprises at least an attribute class table and an attribute value table.

3. A system according to claim 2, wherein the attribute class table comprises a set of product, service, content or information attributes.

4. A system according to claim 3, wherein the set of product, service, content or information attributes comprises at least one of product, service, content or information price data, product, service, content or information availability data, and product, service, content or information specification data.

5. A system according to claim 1, wherein the searchable catalog index is accessible via a networked client.

6. A system according to claim 5, wherein the networked client comprises a browser.

7. A system according to claim 6, wherein the browser comprises an integrated search and browse interface.

8. A system according to claim 7, wherein the integrated search and browse interface comprises an input dialogue to receive search terms to search against the searchable catalog index.

9. A system according to claim 7, wherein the integrated search and browse interface comprises a navigable product, service, content or information taxonomy.

10. A system according to claim 1, further comprising a third interface to a structured database containing additional product, service, content or information data, the indexing engine communicating with the third interface to the structured database to access the additional product, service, content or information data and store the additional product, service, content or information data to the catalog index.

11. A method for generating a searchable catalog index, comprising:
accessing a source database storing a set of product, service, content or information descriptions;
receiving the set of product, service, content or information descriptions in an indexing engine; and
generating a structured representation of the product, service, content or information descriptions.

12. A method according to claim 11, further comprising storing the structured representation to a searchable catalog index.

13. A method according to claim 12, wherein the searchable catalog index comprises at least an attribute class table and an attribute value table.

14. A method according to claim 13, wherein the attribute class table comprises a set of product, service, content or information attributes.

15. A method according to claim 14, wherein the set of product, service, content or information attributes comprises at least one of product, service, content or information price data, product, service, content or information availability data, and product, service, content or information specification data.

16. A method according to claim 12, wherein the searchable catalog index is accessible via a networked client.

17. A method according to claim 16, wherein the networked client comprises a browser.

18. A method according to claim 17, wherein the browser comprises an integrated search and browse interface.

19. A method according to claim 18, further comprising receiving search terms to search against the searchable catalog index via an input dialogue.

20. A method according to claim 18, wherein the integrated search and browse interface comprises a navigable product, service, content or information taxonomy.

21. A method according to claim 12, further comprising accessing a structured database containing additional product, service, content or information data, and storing the additional product, service, content or information data to the catalog index.

22. A searchable catalog index, the searchable catalog index being generated according to a method of:
accessing a source database storing a set of product, service, content or information descriptions;
receiving the set of product, service, content or information descriptions in an indexing engine;
generating a structured representation of the product, service, content or information descriptions; and
storing the structured representation to a searchable catalog index.

23. A searchable catalog index according to claim 22, wherein the searchable catalog index comprises at least an attribute class table and an attribute value table.

24. A searchable catalog index according to claim 23, wherein the attribute class table comprises a set of product, service, content or information attributes.

25. A searchable catalog index according to claim 24, wherein the set of product, service, content or information attributes comprises at least one of product, service, content or information price data, product, service, content or information availability data, and product, service, content or information specification data.

26. A searchable catalog index according to claim 22, wherein the searchable catalog index is accessible via a networked client.

27. A searchable catalog index according to claim 26, wherein the networked client comprises a browser.

28. A searchable catalog index according to claim 27, wherein the browser comprises an integrated search and browse interface.

29. A searchable catalog index according to claim 28, wherein the method further comprises receiving search terms to search against the searchable catalog index via an input dialogue.

30. A searchable catalog index according to claim 28, wherein the integrated search and browse interface comprises a navigable product, service, content or information taxonomy.

31. A searchable catalog index according to claim 22, wherein the method further comprises accessing a structured database containing additional product, service, content or information data, and storing the additional product, service, content or information data to the catalog index.
